(19) United States
(12) Patent Application Publication
(10) Pub. No.: US 2011/0232031 A1
(43) Pub. Date: Sep. 29, 2011

(54) LEASH HANDLE

(76) Inventor: Steve Salais, Modesto, CA (US)

(21) Appl. No.: 12/732,129

(22) Filed: Mar. 25, 2010

(51) Int. Cl. A01K 29/00

(52) U.S. Cl. 16/111.1

(57) ABSTRACT

A leash handle includes a hollow tubular body having a first end and a second end. A handle end having a knob is partially inserted into the second end of the hollow tubular body so that the knob remains outside the hollow tubular body. A first chamber within the hollow tubular body is accessible when the handle end is removed from the hollow tubular body. A second chamber of the hollow tubular body is accessible through an opening in the hollow tubular body adjacent to the tip.

### BACKGROUND

Pet leash systems sometimes include storage compartments that can be used by a pet owner for limited storage of items like plastic bags for litter collection and small flashlights. Such leashes typically provide only a very small amount of storage, or provide a larger amount of storage from which it is inconvenient for the pet owner to simultaneously control the pet while accessing items stored within the storage compartment.

### SUMMARY

In accordance with embodiments of the invention, a leash handle is presented. The leash handle includes a hollow tubular body having a first end and a second end. A handle end having a knob is partially inserted into the second end of the hollow tubular body so that the knob remains outside the hollow tubular body. A first chamber within the hollow tubular body is accessible when the handle end is removed from the hollow tubular body. A second chamber of the hollow tubular body is accessible through an opening in the hollow tubular body adjacent to the first end.

Optional features are part of the leash handle in various embodiments. For example, the leash handle can include a tip attached to the first end of the hollow tubular body. The tip is attached to a leash. A wrist strap may be attached to the knob. Alternatively, or in addition, a plurality of leash holders attached to the hollow tubular body are used to hold a leash substantially across an entire length, from the first end to the second end, of the hollow tubular body.

### BRIEF DESCRIPTION OF THE DRAWING

FIG. 1 is a simplified diagram of a disassembled leash handle able to store two types of mace and litter bags in a manner that allows fast and easy access by a pet owner in accordance with an embodiment of the invention.

FIG. 2 is a simplified diagram showing the leash handle of FIG. 1 partially assembled with items stored by the leash handle in locations that are readily accessible in accordance with an embodiment of the invention.

FIG. 3 is a simplified diagram showing the leash handle of FIG. 1 and FIG. 2 fully assembled with items stored by the leash handle in locations that are readily accessible in accordance with an embodiment of the invention.

FIG. 4 is a simplified diagram showing a fully assembled leash handle with items stored by the leash handle in locations that are readily accessible in accordance with another embodiment of the invention.

FIG. 5 is a simplified diagram of an assembled leash handle able to store two types of mace a flashlight and litter bags in a manner that allows fast and easy access by a pet owner in accordance with an embodiment of the invention.

FIG. 6 is a simplified diagram showing a fully assembled leash handle with items stored by the leash handle in locations that are readily accessible in accordance with another embodiment of the invention.

### DESCRIPTION OF THE EMBODIMENT

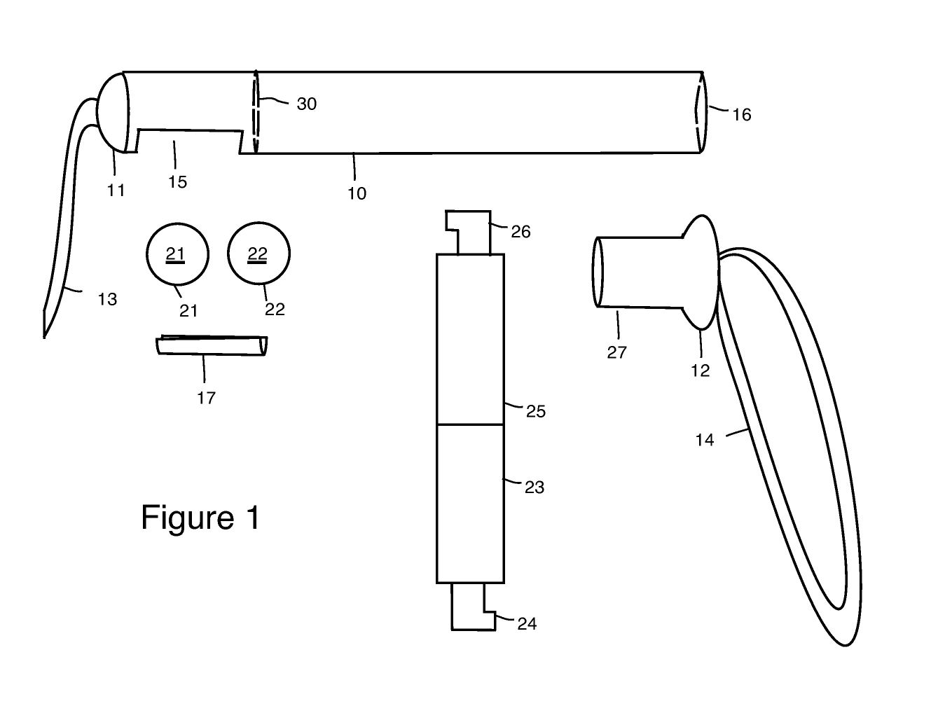

FIG. 1 is a simplified diagram of a disassembled leash handle able to store two types of mace and litter bags in a manner that allows fast and easy access by a pet owner. Dog mace 25 has a spray nozzle 26 and is suitable for fending off an attack by a dog or other animal. Human mace 23 has a spray nozzle 24 and is suitable for fending off an attack by a human. For ease of access dog mace 25 is joined together with human mace 23.

A plastic bag 21 and a plastic bag 22 are compressed into the shape of a ball for easy storage. Plastic bag 21 and plastic bag 22 can be used, for example to collect solid or liquid litter excreted from a pet.

A leash 13 is attached to a pet collar (not shown). Leash 13 is connected to a tubular handle body 10 via a tip 11. For example, tubular handle body 10 is made of plastic, metal or some other suitable material or combination of materials. Tubular handle body 10 is hollow and includes an optional wall 30 dividing the interior into a first storage chamber accessible through an opening 15 and a second chamber accessible through an opening 16.

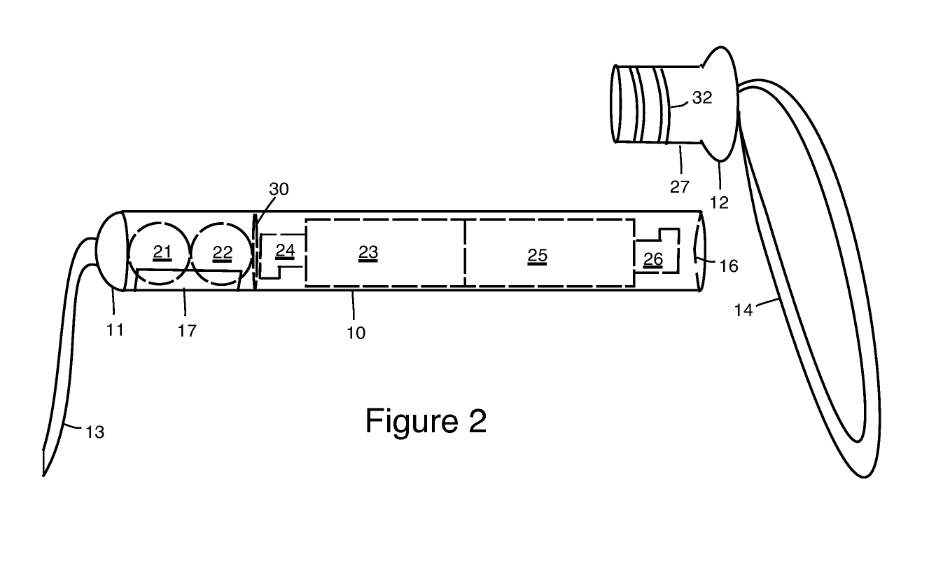

For example, as shown by FIG. 2, plastic bag 21 and plastic bag 22 can be stored in the first chamber. Once plastic bag 21 and plastic bag 22 are stored within the first chamber, a flexible top 17 can be used to close opening 15 securing plastic bag 21 and plastic bag 22 within the first chamber. For example, flexible top 17 is composed of rubber or some other flexible material that allows it to be flexed and partially inserted within opening 15, and once inserted to securely shut opening 15.

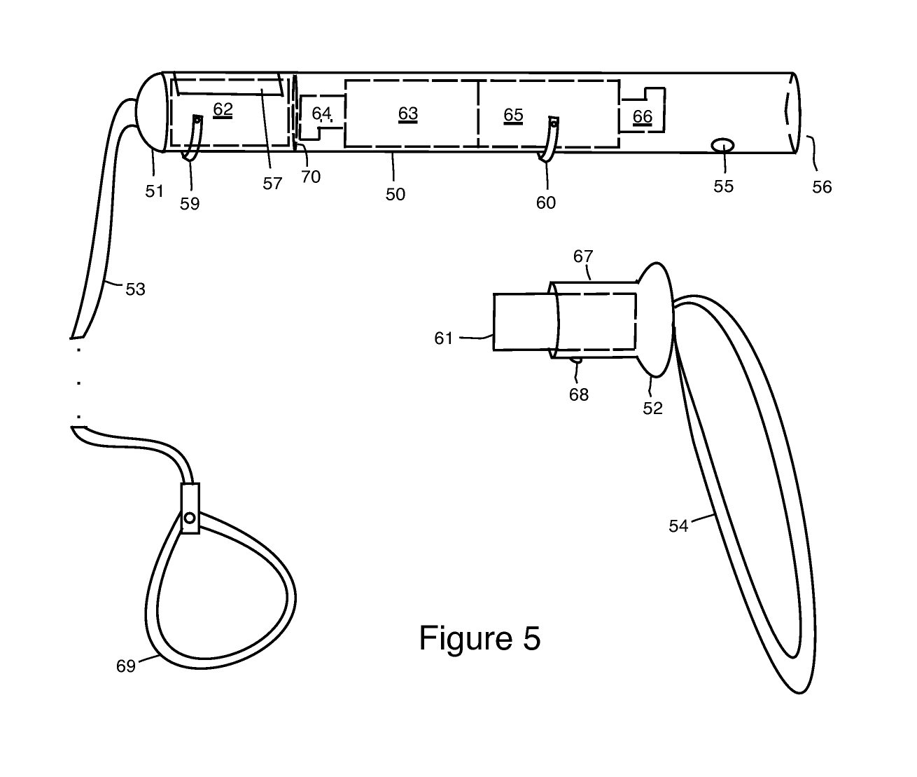

Human mace 23 and dog mace 25 can be placed in the second chamber via opening 16. Once human mace 23 and dog mace 25 are placed within the second chamber, these can be secured by inserting handle end 27 into opening 16. Handle end 27 is hollow allowing part of dog mace 25, including nozzle 26 to be located within handle end 27. Handle end 27 can be tapered, as shown in FIG. 1, assuring a snug fit within opening 16. Alternatively, handle end 27 can be threaded, as shown in FIG. 2, or include a push button, as shown in FIG. 5, to retain handle end 27 in position plugging opening 16.

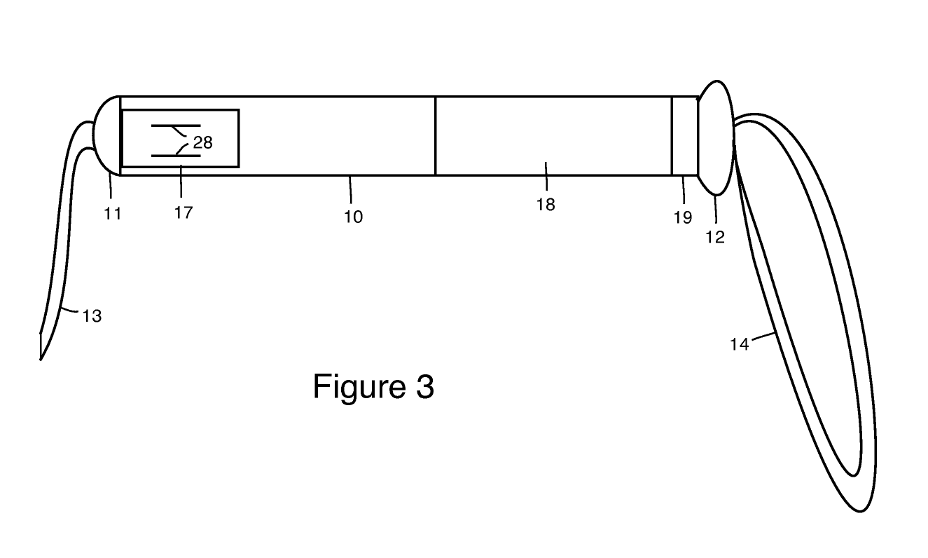

FIG. 3 show the leash handle fully assembled. A rubber grip 18 on tubular handle body 10 allows for a firm grip of the leash handle by a pet owner. A decorative band 19 can be composed of metal, plastic or some other material. If needed, decorative band 19 can be made of stronger material than the rest of tubular handle body adding extra sturdiness and durability to the area around opening 16. Decorative band 19 typically complements a color scheme of tubular handle body 10 and knob 12.

A knob 12 of handle end 27 remains outside the second chamber of tubular handle body 10 when the remainder of handle end 27 is inserted through opening 16 into the second chamber of tubular handle body 10. A wrist strap 14 is attached to knob 12. Knob 12 can be composed of, for example, wood, plastic metal and along with decorative band 19 conforms to a style theme adding class to the overall appearance of the tubular handle body 10.

On flexible top 17 there is shown tabs 28. Tabs 28 are ridges which aid a pet owner in flexing flexible top 17 in order to either remove flexible top 17 from opening 15 or to place flexible top within opening 15.

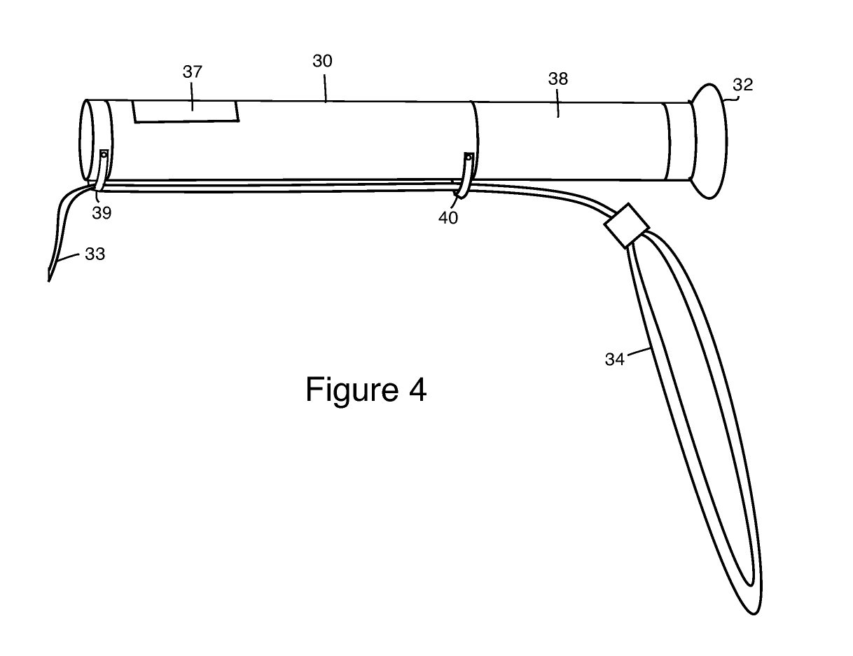

FIG. 4 shows an alternative embodiment of a leash handle. A tubular handle body 30 is made of plastic, metal or some other suitable material or combination of materials. Tubular handle body 30 is hollow and includes one or more storage chambers. A flexible top 37 can be used to close an opening in handle body 30. A rubber grip 38 on tubular handle body 30 allows for a firm grip of the leash handle by a pet owner.

A knob 30 remaining outside tubular handle body 30 can be composed of, for example, wood, plastic metal and is typically decorative. A leash 33 is strung through a leash hold 39 and a leash holder 40 which serve to hold leash 33 next to leash handle 30. A wrist strap 34 can be worn on the wrist of a pet owner.

FIG. 5 is a simplified diagram of a partially assembled leash handle able to store two types of mace and litter bags in a manner that allows fast and easy access by a pet owner. Dog mace 65 has a spray nozzle 66 and is suitable for fending off an attack by a dog or other animal. Human mace 63 has a spray nozzle 64 and is suitable for fending of a personal attack. For ease of access dog mace 65 is joined together with human mace 63.

Plastic bags within a roll of plastic bags 62 can be used, for example to collect solid or liquid litter excreted from a pet.

A leash 53 is attached to a pet collar 69. Leash 53 is connected to a tubular handle body 50 via a tip 51. For example, tubular handle body 50 is made of plastic, metal or some other suitable material or combination of materials. Tubular handle body 50 is hollow and includes an optional wall 70 dividing the interior into a first storage chamber accessible through an opening covered by a flexible top 57 and a second storage chamber accessible through an opening 56.

As shown by FIG. 5, roll of plastic bags 62 can be stored for example, in the first chamber. Flexible top 57 can be used to secure roll of plastic bags 62 within the first chamber. For example, flexible top 57 is composed of rubber or some other flexible material.

Human mace 63 and dog mace 65 can be placed in the second chamber via opening 56. Once human mace 63 and dog mace 65 are placed within the second chamber, these can be secured by also inserting handle end 67 into opening 56.

Handle end 67 is hollow allowing a small flashlight 61 to be stored therein. There is extra room within the interior of handle body 50 to accommodate storage of small flashlight 67 when handle end 67 is inserted into opening 56 of handle body 50.

A wrist strap 64 is attached to a knob 52 of handle end 67. Handle end 67 includes a push button 67 which fits within hole 55 of handle body 50 and serves to secure handle end 67 snugly on handle body 50.

Knob 52 remains outside the second chamber of tubular handle body 50 when the remainder of handle end 67 is inserted into the second chamber of tubular handle body 50. Knob 52 can be composed of, for example, wood, plastic metal and is typically decorative.

A second leash, and if desired additional leashes, may be strung through a leash holder 59 and a leash holder 60. Leash holder 59 and leash holder 50 serve to hold the second leash and any additional leashes next to leash handle 50, simplifying the control of more than one pet.

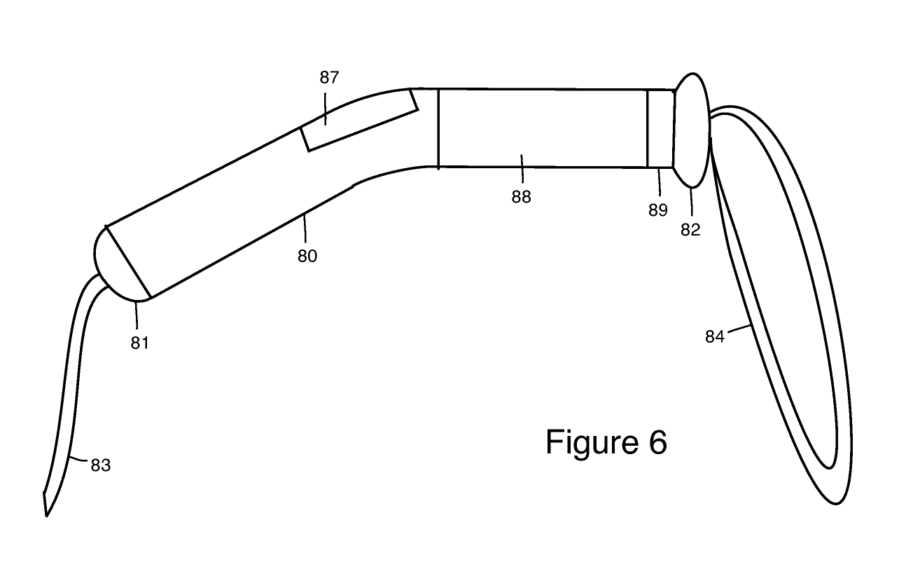

FIG. 6 shows another example of a fully assembled leash handle. A tubular handle body 80 is in a bent tubular shape, as shown. A rubber grip 88 on tubular handle body 80 allows for a firm grip of the leash handle by a pet owner. A decorative band 89 can be composed of metal, plastic or some other material. If needed, decorative band 89 can be made of stronger material than the rest of tubular handle body adding extra sturdiness and durability to the area around opening 86. Decorative band 89 typically complements a color scheme of tubular handle body 80 and knob 82. A leash 83 is connected to tubular handle body 80 via a tip 81. A flexible top 87 can be used to cover an opening for a middle chamber within tubular handle body 80. For example, plastic bags can be stored in the middle chamber while human mace is stored on a first side chamber to the middle chamber and dog mace is stored in a second side chamber to the middle chamber.

A wrist strap 84 is attached to a knob 82. Knob 82 can be composed of, for example, wood, plastic metal and along with decorative band 89 conforms to a style theme adding class to the overall appearance of the tubular handle body 80.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention, which is set forth in the following claims.

What is claimed:

1. A leash handle comprising:
a hollow tubular body having a first end and a second end;
a tip attached to the first end of the hollow tubular body, the tip being attached to a leash;
a handle end having a knob, the handle end being partially inserted into the second end of the hollow tubular body so that the knob remains outside the hollow tubular body;
a wrist strap attached to the knob;
a mace dispenser, the mace dispenser dispensing dog mace through a first nozzle and the mace dispenser dispensing human mace through a second dispenser, the mace being stored in a first chamber of the hollow tubular body, the first chamber being accessible when the handle end is removed from the hollow tubular body; and
plastic bags stored in a second chamber of the hollow tubular body, the plastic bags being accessible through an opening in the hollow tubular body adjacent to the tip.

2. A leash handle as in claim 1 additionally comprising:
a flashlight stored in the first chamber of the hollow tubular body.

3. A leash handle as in claim 1 additionally comprising:
a plurality of leash holders attached to the hollow tubular body, the leash holders for holding an additional leash next to the leash handle.

4. A leash handle as in claim 1 wherein the plastic bags are each compressed approximately into a shape of a ball.

5. A leash handle as in claim 1 wherein the plastic bags are stored within the second chamber as a roll of plastic bags.

6. A leash as in claim 1 additionally comprising:
a flexible top that shuts the opening in the hollow tubular body adjacent to the tip, the flexible top securing the plastic bags in the second chamber.

7. A leash handle as in claim 1 additionally comprising:
a flashlight partially stored in a hollow portion of the handle end.

8. A leash handle comprising:
a hollow tubular body having a first end and a second end;
a handle end having a knob, the handle end being partially inserted into the second end of the hollow tubular body so that the knob remains outside the hollow tubular body;
a mace dispenser, the mace dispenser dispensing dog mace through a first nozzle and the mace dispenser dispensing human mace through a second dispenser, the mace being stored in a first chamber of the hollow tubular body, the first chamber being accessible when the handle end is removed from the hollow tubular body;
plastic bags stored in a second chamber of the hollow tubular body, the plastic bags being accessible through an opening in the hollow tubular body adjacent to the first end of the hollow tubular body; and
a plurality of leash holders attached to the hollow tubular body, the leash holders for holding a leash substantially across an entire length, from the first end to the second end, of the hollow tubular body.

9. A leash handle as in claim 8 additionally comprising:
a flashlight stored in the first chamber of the hollow tubular body.

10. A leash handle as in claim 8 wherein the plastic bags are each compressed approximately into a shape of a ball.

11. A leash handle as in claim 8 wherein the plastic bags are stored within the second chamber as a roll of plastic bags.

12. A leash as in claim 8 additionally comprising:
a flexible top that shuts the opening in the hollow tubular body adjacent to the tip, the flexible top securing the plastic bags in the second chamber.

13. A leash handle as in claim 8 additionally comprising:
a flashlight partially stored in a hollow portion of the handle end.

14. A leash handle comprising:
a hollow tubular body having a first end and a second end;
a tip attached to the first end of the hollow tubular body, the tip being attached to a leash;
a handle end having a knob, the handle end being partially inserted into the second end of the hollow tubular body so that the knob remains outside the hollow tubular body;
a wrist strap attached to the knob;
a first chamber within the hollow tubular body, the first chamber being accessible when the handle end is removed from the hollow tubular body; and
a second chamber of the hollow tubular body, the second chamber being accessible through an opening in the hollow tubular body adjacent to the tip.

15. A leash handle as in claim 14 additionally comprising:
a flashlight stored in the first chamber of the hollow tubular body.

16. A leash handle as in claim 14 additionally comprising:
a plurality of leash holders attached to the hollow tubular body, the leash holders for holding an additional leash next to the leash handle.

17. A leash handle as in claim 14 wherein plastic bags each compressed approximately into a shape of a ball are stored in the second chamber.

18. A leash handle as in claim 14 wherein a roll of plastic bags is stored within the second chamber.

19. A leash as in claim 14 additionally comprising:
a flexible top that shuts the opening in the hollow tubular body adjacent to the tip.

20. A leash handle as in claim 14 wherein the hollow tubular body is in a bent tubular shape.
